(19) United States
(12) Patent Application Publication
(10) Pub. No.: US 2005/0034089 A1
(43) Pub. Date: Feb. 10, 2005

(54) Area based power estimation

(76) Inventors: Tyson R. McGuffin, Fort Collins, CO (US); Thomas W. Chen, Fort Collins, CO (US)

Correspondence Address: HEWLETT-PACKARD COMPANY;Intellectual Property Administration, P.O. Box 272400, Fort Collins, CO, 80527-2400, US

(21) Appl. No.: 10/635,283

(22) Filed: Aug. 6, 2003

(51) Int. Cl. G06F 9/45

(52) U.S. Cl. 716/5

(57) ABSTRACT

Systems and methods are provided that can be utilized to estimate power associated with a circuit design. The estimated power is determined by evaluating a functional relationship of estimated power based on calculated transistor gate area. One or more power coefficients can be employed with transistor gate area calculations of a circuit design to compute relative power estimates of one or more circuit design sizing instances.

### TECHNICAL FIELD

The present invention relates to circuit analysis and, more particularly, to an approach to estimate power consumption of a circuit design employing transistor gate area.

### BACKGROUND OF INVENTION

Power consumption is becoming an increasing concern in the design of integrated circuits (ICs), particularly for very large scale integration (VLSI) chip design. Increases in power consumption are outpacing the advantages of advances in scaling in silicon technologies, and the benefits of reducing power supply voltages. To address this concern, many computer-aided design (CAD) tools have been developed to measure or estimate power consumption in VLSI designs. The estimated power consumption is employed to help designers meet target power parameters and ultimately facilitate design convergence.

Techniques used to estimate power consumption in VLSI chip designs can be divided into two general groups: simulation-based techniques and statistics-based techniques. For both types of techniques, the power consumption is based on both the static power consumption of a circuit and the dynamic power consumption of the circuit. The static power consumption is computed based on leakage power. Leakage power (or subthreshold leakage) refers to the fact that a cell or transistor in a steady state condition (e.g., logic-0, logic-1) exhibits a leakage current that flows from the gate source to its drain since the gate is not completely shut off causing some current to flow from the supply voltage (V_{DD}) through the gate to ground (GND). Additionally, leakage current can flow through the reverse bias junction between the diffusion and substrate layers.

The dynamic power consumption is computed based on estimated switching activities of a circuit or a defined part of a circuit. In contrast to static power, dynamic power is only dissipated when the circuit is active. Additional power consumption can be a result of gate leakage. Gate leakage is the gate-to-source leakage current caused by tunneling effects into the gate oxide material of the gate, which increases as the gate oxide thickness decreases.

Existing simulation-based approaches are employed for performance and power consumption analysis of VLSI designs. These simulation approaches tend to be highly dependent on the input patterns (or input vectors) used to stimulate the circuit model. That is, the power estimation tool usually requires varying input patterns designed specifically for power estimation. Optimization techniques are used to optimize the performance, size and power consumption of a design. The optimization techniques usually employ a single input pattern that is utilized to automatically resize standard cell transistors to find the combination that will best meet power and speed requirements. Power estimation for both the simulation and optimization techniques is computationally expensive and time consuming.

### SUMMARY OF INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some general concepts of the invention in a simplified form as a prelude to the more detailed description that is presented later.

The present invention relates generally to systems and methods to estimate power consumption. One aspect of the present invention provides a power estimation engine that determines a relative estimation of power for at least one unit of a circuit design based on a predetermined correlation that characterizes device power as a function of transistor gate area.

Another aspect of the present invention relates to a system for estimating power for at least one unit of a circuit design. The system comprises a first power estimator that determines an estimation of relative power associated with high voltage threshold (HVT) devices by employing a predetermined functional relationship of HVT transistor gate area to HVT device power. The system also comprises a second power estimator that determines an estimation of relative power associated with low voltage threshold (LVT) devices by employing a functional relationship of LVT transistor gate area to LVT device power. An estimation of power for the at least one of a circuit design can be determined by adding the estimation of powers from the first power estimator and the second power estimator.

In yet another aspect of the present invention relates to a method for power estimation of a circuit design. The method comprises calculating the transistor gate area associated with a circuit design. A relative power is estimated by computing a predetermined characterization as a function of transistor gate area.

### BRIEF DESCRIPTION OF THE DRAWINGS

FIG. 1 illustrates a block diagram of a system for estimating power in accordance with an embodiment of the present invention.

FIG. 2 illustrates a block diagram of a system for generating power coefficients in accordance with an embodiment of the present invention.

FIG. 3 is a scatter plot of dynamic power versus transistor gate area associated with one particular statistical analysis in accordance with an embodiment of the present invention.

FIG. 4 is a scatter plot of static power versus transistor gate area associated with one particular statistical analysis in accordance with an embodiment of the present invention.

FIG. 5 illustrates a block diagram of a power estimation engine in accordance with an embodiment of the present invention.

FIG. 6 illustrates a schematic diagram of a High Voltage Threshold (HVT) device power estimator in accordance with an embodiment of the present invention.

FIG. 7 illustrates a schematic diagram of a Low Voltage Threshold (LVT) device power estimator in accordance with an embodiment of the present invention.

FIG. 8 illustrates a schematic diagram of a gate leakage power estimator in accordance with an embodiment of the present invention.

FIG. 9 is a flow diagram illustrating a methodology for estimating power in accordance with an embodiment of the present invention.

FIG. 10 is a flow diagram illustrating a methodology for estimating power in accordance with another embodiment of the present invention.

### DETAILED DESCRIPTION

The present invention relates generally to systems and methods that can be utilized to estimate power (e.g., associated with a circuit design). The estimated power is determined by evaluating a functional relationship of power based on transistor gate area (e.g., total transistor gate area associated with a circuit design). The functional relationship is determined by analyzing power data and corresponding transistor gate area calculations of a plurality of circuit sizing instances, and correlating transistor gate area calculations with device power to characterized power as a function of transistor gate area and one or more power coefficients. The one or more power coefficients can be employed with transistor gate area calculations of a circuit design to compute relative power estimates of one or more circuit design sizing instances without computationally expensive and time consuming power estimation algorithms.

The relative power estimates based on transistor gate area calculation can be computed for one or more units. For example, in a circuit design, a given unit can correspond to a node or other juncture between adjacent components, structures or blocks, as well as a circuit component, a functional or structural block, or any combination thereof. Power is estimated for a given unit of the design based on one or more predefined power coefficients and transistor gate area calculations. The transistor gate area calculations refer to the total transistor gate area associated with the functional circuitry (e.g., transistors and other device circuitry) of the one or more units of the circuit design. For example, the transistor gate area of a transistor can be computed by multiplying the width (W) by the length (L) of the transistor gate. The total transistor gate area can be computed by summing up the gate areas of all of the transistors in the circuit design.

Recently, leakage power minimization has prompted integrated circuit manufacturers to employ dual threshold voltage transistor processes. Low voltage threshold (LVT) transistor devices are used in performance-critical blocks to meet target clock frequency requirements, and high voltage threshold transistors are used in blocks with delay slacks to minimize overall leakage power. To improve performance, upsizing of a HVT transistor device can be traded off against using a LVT transistor device. However, very few optimization techniques consider transistor sizing and voltage threshold allocation as an integrated problem. The present invention can provide relative power estimates for both HVT devices and LVT devices.

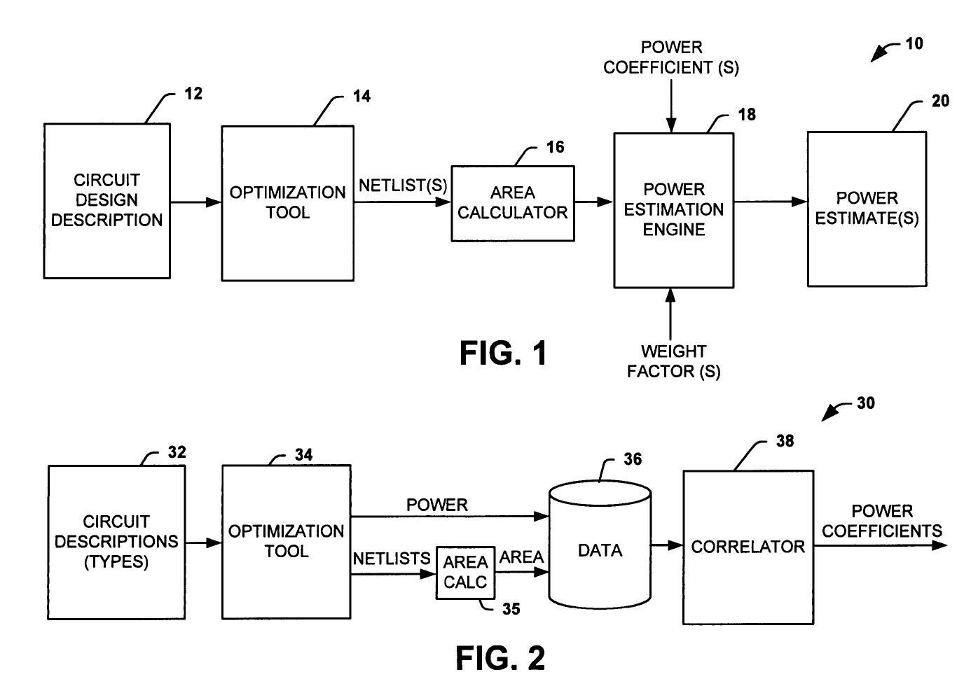

FIG. 1 illustrates a system 10 that can be implemented to estimate power in accordance with an aspect of the present invention. The system 10 can be a computer, a server or some other computer readable medium that can execute computer instructions. The system 10 includes a power estimation engine 18 that performs power estimation based on area calculations of a circuit design. The power estimation engine 18 also employs one or more power coefficients that provide a correlation that functionally relates transistor gate area of a circuit design with the estimated power consumption of the circuit design. For example, the one or more power coefficients can include a slope or multiplier coefficient and an offset coefficient that define estimated power based on a substantially linear relationship with transistor gate area.

The one or more power coefficient can be predetermined or predefined by correlating a plurality of transistor gate areas and a plurality of power estimates for plurality of circuit sizing instances based on one or more circuit design types (e.g., decoder device, central processing device, memory device, arithmetic logic unit). A circuit sizing instance is one particular optimization of a circuit design, for example, that is generated by an optimization tool to improve speed and power associated with the circuit design. The correlation can then be utilized to functional relate relative power to transistor gate area. It is to be appreciated that the power coefficients can be employed to establish other relationships (e.g., polynomial, logarithmic, exponential, etc.) between estimated power and transistor gate area based on a particular implementation.

The power estimation engine 18 also can employ one or more weight factors that provide associated weights to different power types (e.g., dynamic power, static power, gate leakage power) and/or different device types (e.g., HVT device types, LVT device types). Additionally, separate power coefficients can be employed to functionally relate device power to transistor gate area for different power types and different device types. Some relationships can be based on multiplier coefficients and offset coefficients, while other relationships can be based solely on multiplier coefficients or offset coefficients.

The power estimation engine 18 receives area calculations from an area calculator 16. The area calculator 16 can parse through a netlist to determine transistor gate area. The area calculator 16 can be implemented as part of the power estimation engine 18. The netlist can be provided by an optimization tool 14 that executes a sizing and timing algorithm to optimize a circuit design. For example, the optimization tool 14 can be a static timing analysis tool (e.g., PATHMILL® by Synopsys) for block and chip timing verification. Alternatively, the optimization tool 14 can be a transistor autosizer (e.g., AMPS® by Synopsys). Most transistor autosizers rely on heuristic approaches that focus on finding the best combination that will meet user-defined power and speed goals without changing the functionality of the design. The transistor autosizers employ an original circuit design description to generate a plurality of circuit sizing instances that define different optimized cell netlist configurations.

A circuit design description 12 provides information to the optimization tool such as transistor netlists of the standard cells, the design netlists, the design parasitic data and timing constraints. The optimization tool 14 then generates a list of optimized cell netlist configurations that the area calculator 16 parses to generate an calculated transistor gate area. The power estimation engine 18 then computes an estimated power employing the area calculations, the one or more power coefficients and the one or more weight factors to provide a plurality of power estimates associated with respective circuit sizing instances.

The power estimates are based on a correlation of transistor gate area to device power without the consideration of other device power characteristics (e.g., device delay, device load). In the power estimates of the present invention, accuracy is sacrificed for a substantial improvement in computational time. However, since each power computation employs similar power coefficients and weight factors, each power estimate can be compared relative to one another to establish an increase or decrease (e.g., trend) in device power consumption to provide a substantially fast power consumption estimate associated with different circuit sizing instances. A selected group of power estimates and associated circuit sizing instances can then be employed to determine actual power consumption associated with the selected circuit instances utilizing a more comprehensive power estimation tool.

FIG. 2 illustrates a system 30 for correlating power with transistor gate area calculations in accordance with an aspect of the present invention. The system 30 includes an optimization tool 34 that generates a plurality of circuit size instances employing a circuit description 32 of one or more circuit types (e.g., decoder device, central processing unit, arithmetic logic unit, memory). For example, a circuit description (e.g., transistor netlists, design netlist, design parasitic data, timing constraints) of a first circuit type is provided to the optimization tool 34. The optimization tool 34 then provides netlists and device power estimates associated with one or more circuit sizing instances of that circuit type. The device power estimates by the optimization tool 34 are computationally expensive and time consuming, but are only performed to determine power coefficients that characterize circuit design transistor gate area with circuit design power consumption.

An area calculator 35 parses through the netlist(s) and computes the transistor gate area associated with the one or more circuit sizing instances, which is then stored in a database 36 with the circuit sizing instance associated power estimation. One or more circuit type descriptions can be provided to the optimization tool 34 to provide a plurality of additional area and associated power estimates for each circuit type to be stored in the database 36. A correlator 38 is then employed to determine an associated relationship between the power estimate data and the transistor gate area of the one or more circuit types. The correlator 38 then determines one or more power coefficients that associates estimated power with transistor gate area. For example, by applying a regression technique (e.g., least means square, parametric regression, non-parametric regression) to the area data and associated power data stored in the database 36. The one or more power coefficients can then be employed to perform efficient relative power estimates utilizing the netlists generated associated with one or more circuit sizing instances, for example, from an optimization tool, such that the power estimation algorithm performed by the optimization tool can be disabled.

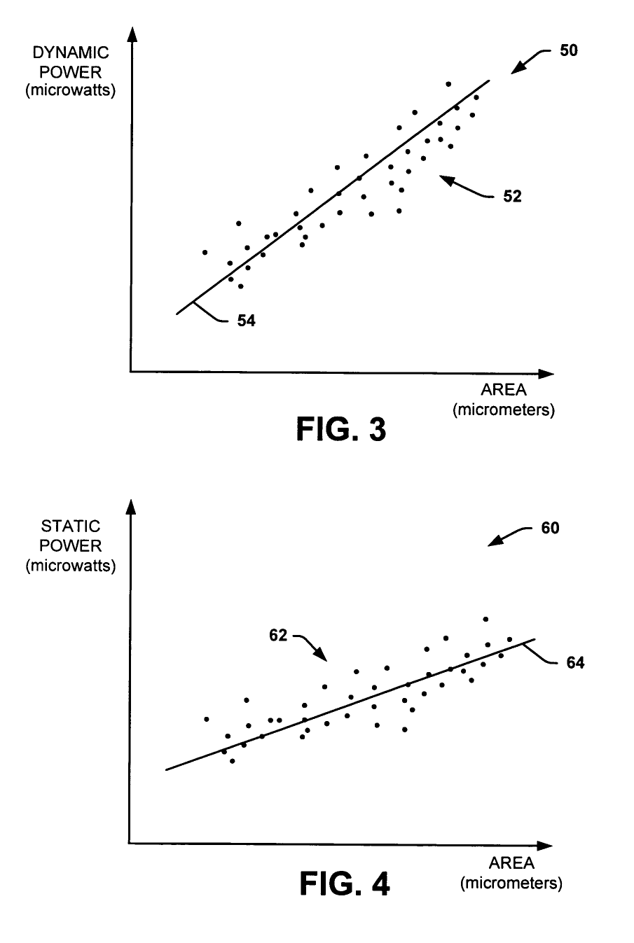

FIG. 3 illustrates a scatter plot 50 of dynamic power (microwatts) versus transistor gate area (micrometers) for power estimation data 52 plotted as a function of associated area data in accordance with an aspect of the present invention. The power estimation data as a function of area data can be generated by an optimization tool for a plurality of different circuit sizing instances for one or more circuit types (e.g., decoder, central processing unit, memory device, arithmetic logic unit). The scatter plot 50 illustrates that a linear relationship exists between transistor gate area and dynamic power associated with the plurality of circuit design instances. A line 54 can be defined by performing a regressions analysis (e.g., least means square) on the dynamic power and area data to determine an associated slope or multiplier coefficient and an associated offset coefficient. It has also been determined that a similar relationship exists for HVT transistor gate area versus HVT dynamic power and LVT transistor gate area versus LVT dynamic power. Therefore, separate dynamic power multiplier coefficients and/or offset coefficients can be determined for HVT devices and LVT devices.

FIG. 4 illustrates a scatter plot 60 of static power (microwatts) versus transistor gate area (micrometers) for power estimation data 62 as a function of associated area data in accordance with an aspect of the present invention. The power estimation data as a function of transistor gate area data can be generated by an optimization tool for a plurality of different circuit sizing instances for one or more circuit types (e.g., decoder, central processing unit, memory device, arithmetic logic unit). The scatter plot 60 illustrates that a linear relationship exists between transistor gate area and static power associated with the plurality of circuit design instances. A line 64 can be defined by performing a regressions analysis (e.g., least means square) or other correlation techniques on the static power and area data to determine an associated slope or multiplier coefficient and offset coefficient. It is also been determined that a similar relationship exists for HVT transistor gate area versus HVT static power and LVT transistor gate area versus LVT static power. Therefore, separate static power slope coefficients and offset coefficients can be determined for HVT devices and LVT devices.

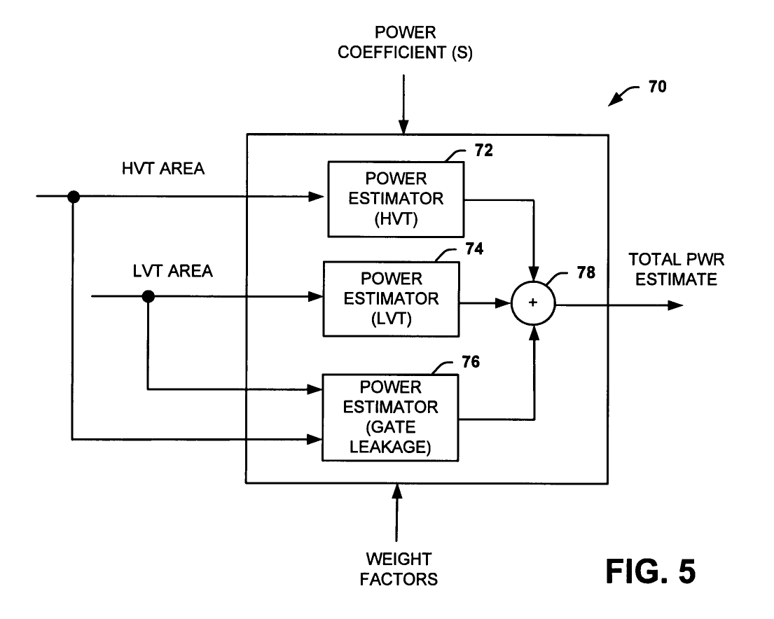

FIG. 5 illustrates a power estimation engine 70 in accordance with an aspect of the present invention. The power estimation engine 70 can include hardware (e.g., a computer) and/or software programmed to execute the power estimation. The power estimation engine 70 includes a first power estimator 72 that determines an estimation of power associated with HVT devices based on a HVT area calculation. The first power estimator 70 employs one or more HVT power coefficients to compute an estimated power for HVT devices by evaluating a functional relationship (e.g., a mathematical relationship) between HVT transistor gate area and HVT device power. The one or more HVT coefficients can include separate coefficients for both static and dynamic power.

For example, the first power estimator 72 can evaluate an equation such as P_{HVT}=m_{HVT}*A_{HVT}+b_{HVT}) where m_{HVT} is a slope or multiplier coefficient, b_{HVT} is an offset coefficient, A_{HVT} is the area of the HVT devices, and P_{HVT} is the power estimate. Alternatively, the first power estimator 72 can evaluate an equation such as P_{HVT}=C_{HVT}*A_{HVT} where C_{HVT} is a constant. It is to be appreciated that the functional relationship can be based on a predetermined established correlation that characterizes power and area data for device types (e.g., HVT, LVT) and/or power types (e.g., static, dynamic, gate leakage).

The power estimation engine 70 also includes a second power estimator 74 that determines an estimation of power associated with LVT devices based on a LVT area calculation. The second power estimator 74 employs one or more LVT power coefficients to compute an estimated power for LVT devices by evaluating a functional relationship (e.g., a mathematical relationship) between LVT transistor gate area and LVT device power. The functional relationship associates LVT device power as a function of one or more LVT power coefficients and an LVT transistor gate area calculation. For example, the second power estimator 74 can evaluate an equation such as P_{LVT}=m_{LVT}*A_{LVT}+b_{LVT}), where m_{LVT} is a slope or multiplier coefficient, b_{LVT} is an offset coefficient, A_{LVT} is the area of the LVT devices, and P_{LVT} is the power estimate associated with the LVT devices. Alternatively, the second power estimator 74 can evaluate an equation such as P_{LVT}=C_{LVT}*A_{LVT} where C_{LVT} is a constant. The one or more LVT coefficients can include separate coefficients for both static and dynamic power.

The power estimation engine 70 can also include a third power estimator 76 that determines an estimation of power associated with gate leakage of active devices associated with both LVT devices and HVT devices. The third power estimator 76 employs one or more power coefficients and LVT transistor gate area and HVT transistor gate area calculations to compute an estimated power associated with gate leakage power consumption. The gate leakage power consumption can be determined by evaluating a functional relationship associating LVT and HVT transistor gate area to gate leakage power consumption. The functional relationship can be a linear relationship or a multiplicative relationship similar to as that discussed above.

The first power estimator 72, the second power estimator 74 and the third power estimator 76 also employ one or more weight factors. The one or more weight factors provide appropriate weighting to static power, dynamic power and gate leakage power. The power estimates from the first power estimator 72, the second power estimator 74 and the third power estimator 76 are added via a summer 78 to provide a total power estimate from the associated sizing instance of a circuit design. It is to be appreciated that the functionality of the first power estimator 72, the second power estimator 74, the third power estimator 76 and the summer 78 can be performed by hardware, software and or a combination of hardware and software. For example, the power estimation engine 70 can be implemented as computer executable instructions for performing the functions of the power estimation engine 70.

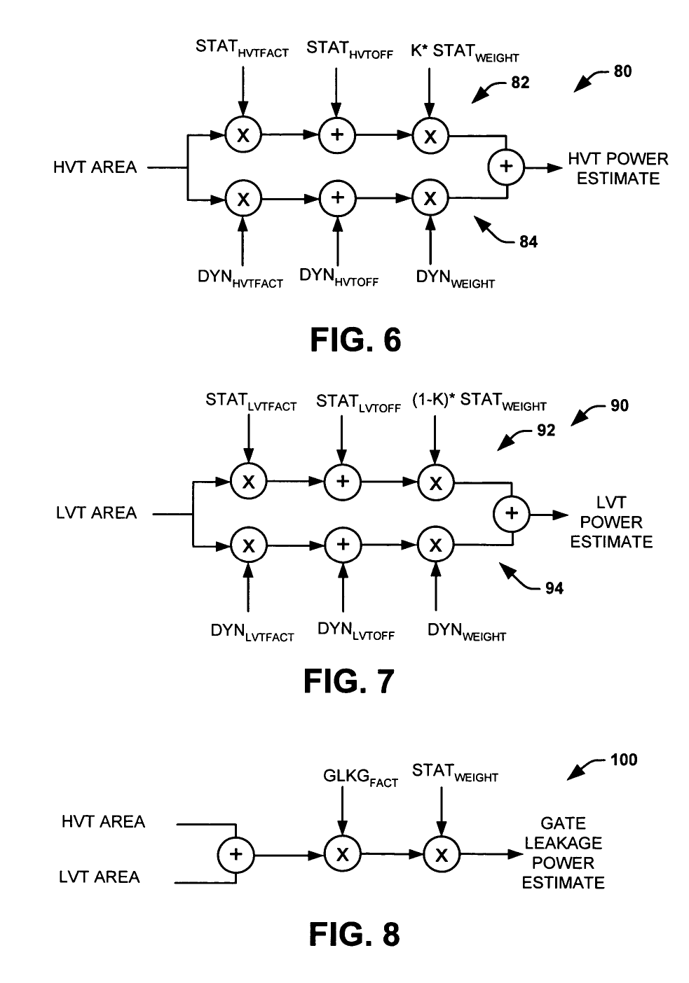

FIG. 6 illustrates a schematic diagram of a HVT power estimator 80 in accordance with an aspect of the present invention. The HVT power estimator 80 includes a static evaluation portion 82 and a dynamic evaluation portion 84. The static evaluation portion 82 receives an HVT area calculation and provides a power estimate associated with static power of the HVT devices. The static evaluation portion 82 multiplies the HVT area calculation by a static multiplier coefficient (STAT_{HVTFACT}) and adds a static offset coefficient (STAT_{HVTOFF}) to the product. The estimated HVT static power is then multiplied by a weight factor (K*STAT_{WEIGHT}) associated with both the static power (STAT_{WEIGHT}) and a weight (K) that weights the HVT device static power versus the LVT device static power, where K is a constant greater than 0 and less than 1.

The dynamic evaluation portion 84 receives an HVT area calculation and provides a power estimate associated with dynamic power of the HVT devices. The dynamic evaluation portion 84 multiplies the HVT area calculation by a dynamic multiplier coefficient (DYN_{HVTFACT}) an adds an offset coefficient (DYN_{HVTOFF}) to the product. The estimated HVT dynamic power is then multiplied by a weight factor (DYN_{WEIGHT}) typically related to an average activity factor (AF) associated with the devices and/or device nodes. The HVT dynamic power estimate and the HVT static dynamic estimate are then added to provide a HVT power estimate. It is to be appreciated that the multipliers or offset coefficients for both static and dynamic power can be employed alone without the other based on predefined statistical analysis and/or anticipated results.

FIG. 7 illustrates a schematic diagram of a LVT power estimator 90 in accordance with an aspect of the present invention. The LVT power estimator 90 includes a static evaluation portion 92 and a dynamic evaluation portion 94. The static evaluation portion 92 receives an LVT area calculation and provides a power estimate associated with static power of the LVT devices. The static evaluation portion multiplies the LVT area calculation by a static multiplier coefficient (STAT_{LVTFACT}) an adds a static offset coefficient (STAT_{LVTOFF}) to the product. The estimated LVT static power is then multiplied by a weight factor ((1-K)*STAT_{WEIGHT})) associated with both the static power (STAT_{WEIGHT}) and the weight (1-K) that weights the LVT device static power versus the HVT device static power.

The dynamic evaluation portion 94 receives an LVT area calculation and provides a power estimate associated with dynamic power of the LVT devices. The dynamic evaluation 94 portion multiplies the LVT area calculation by a dynamic multiplier coefficient (DYN_{LVTFACT}) an adds an offset coefficient (DYN_{LVTOFF}) to the product. The estimated LVT dynamic power is then multiplied by a weight factor (DYN_{WEIGHT}) typically related to an average activity factor (AF) associated with the devices and/or device nodes. The LVT dynamic power estimate and the LVT static dynamic estimate are then added to provide a LVT power estimate. It is to be appreciated that the multipliers or offset coefficients for both static and dynamic power can be employed alone without the other based on predefined statistical analysis and/or anticipated results.

FIG. 8 illustrates a schematic diagram of a gate leakage power estimator 100 in accordance with an aspect of the present invention. The gate leakage power estimator 100 provides an estimate of gate leakage based on both LVT and HVT transistor gate area calculations. The gate leakage power estimator 100 adds the LVT area calculation and the HVT area calculation, which is then multiplied by a gate leakage coefficient (GLKG_{FACT}). It is to be appreciated that an offset coefficient (not shown) can also be employed to determine gate leakage power based on predefined statistical analysis and/or anticipated results. The estimated gate leakage power is then multiplied by the static weight factor (STAT_{WEIGHT}) associated device static power to provide a gate leakage power estimate that can be combined with the LVT power estimate and the HVT power estimate to provide a total power estimate for the circuit design sizing instance.

In one embodiment of the invention, with reference to FIGS. 6-8, static weight (STAT_{WEIGHT}) is determined by evaluating the supply voltage divided by the stacking factor (i.e., V_{DD}/STACK_{FACT}) where the STACK_{FACT} is the average number of inputs per cell (e.g., about 1.7). K is about 0.5 providing one-half of the static weight factor to HVT devices and one-half of the static weight factor to LVT devices. The static HVT multiplier coefficient (STAT_{HVTFACT}) can be evaluated by determining the HVT leakage per unit width over average length (e.g., about 0.72/0.08 or about 9 μA/μm²). The static LVT multiplier coefficient (STAT_{LVTFACT}) can be evaluated by determining LVT leakage per unit width over average length (e.g., about 3.6/0.08 or about 45 μA/μm²).

Dynamic weight (DYN_{WEIGHT}) can be set to be substantially equal to the average activity factor (e.g., about 0.5) of the device. The dynamic HVT multiplier coefficient (DYN_{HVTFACT}) is a predetermined constant (e.g., about 1/27 μA/μm²) and the dynamic LVT multiplier coefficient (DYN_{LVTFACT}) is a predetermined constant (e.g., about 1/24 μA/μm²), for example, predetermined by evaluating a plurality of circuit sizing instances for a plurality of circuit types. The static and dynamic offset coefficients for both HVT and LVT devices are set to zero, while the gate leakage multiplier coefficient (GLKG_{FACT}) can be evaluated by determining the gate leakage per unit width over average length (e.g., 0.125/0.08 or 1.5625 μA/μm^{2).}

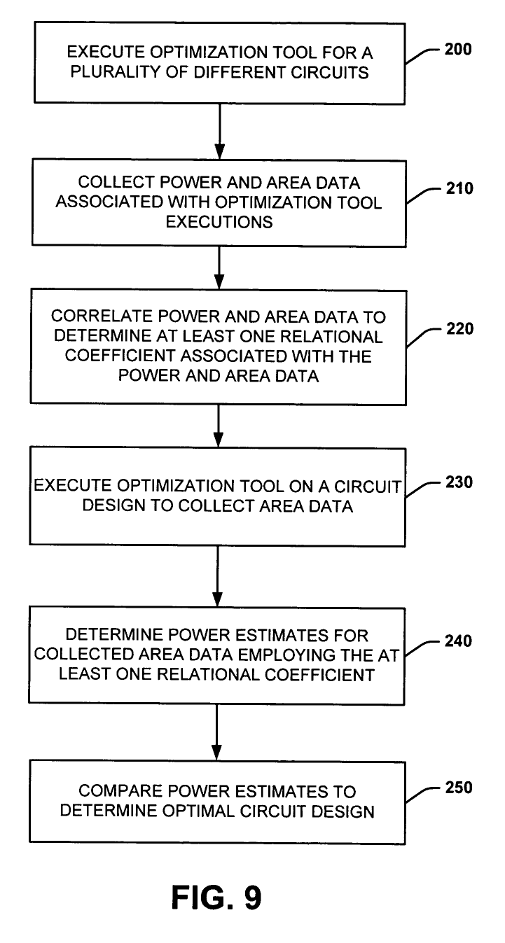

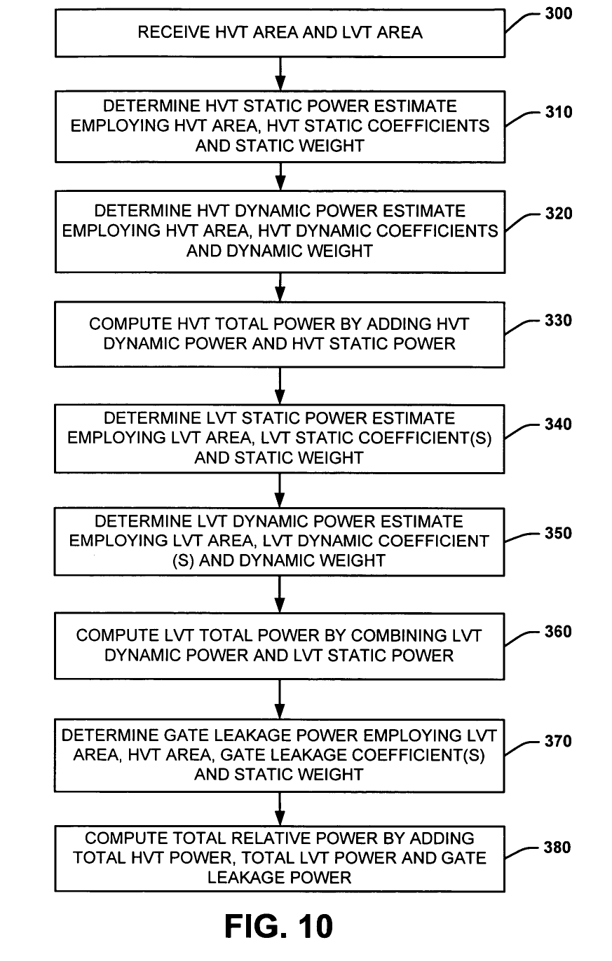

In view of the foregoing structural and functional features described above, a methodology for estimating power, in accordance with an aspect of the present invention, will be better appreciated with reference to FIGS. 9-10. While, for purposes of simplicity of explanation, the methodologies of FIGS. 9-10 are shown and described as being implemented serially, it is to be understood and appreciated that the present invention is not limited to the illustrated order, as some aspects could, in accordance with the present invention, occur in different orders and/or concurrently with other aspects from that shown and described. Moreover, not all illustrated features may be required to implement a methodology in accordance with an aspect of the present invention. It is to be further understood that the following methodologies can be implemented in hardware, software (e.g., computer executable instructions), or any combination thereof.

FIG. 9 illustrates a methodology for estimating power of a circuit design in accordance with an aspect of the present invention. The methodology begins at 200 in which an optimization tool is executed for a plurality of different circuit types (e.g., decoder, central processing unit, memory, arithmetic logic unit) to generate a plurality of power estimates and associated area data. For example, a description of a first circuit type can be provided to an optimization tool that executes a transistor sizing algorithm that generates different optimized netlist configurations and associated power estimates. Area can be determined by parsing the cell netlists to generate a transistor gate area calculation that can be associated with the device power. This can be repeated for a number of different circuit types to generate power and area data across several circuit sizing instances for several circuit types. At 210, the power and area data associated with the optimization tool executions is collected, for example, in a database or the like. The methodology then proceeds to 220.

At 220, the collected power and area data is correlated or characterized to determine at least one relational coefficient that associates transistor gate area data with device power. Separate coefficients can be employed to establish a relationship between transistor gate area for different power types (e.g., dynamic power, static power, gate leakage power) and different device types (e.g., HVT device types, LVT device types). Some coefficients can be employed as multiplier coefficients and/or offset coefficients, while other coefficients can be employed solely as multiplier coefficients. The coefficients can be employed to compute power estimates for a given circuit design substantially faster than the optimization tool. Therefore, power estimates performed by the optimization tool can be disabled.

At 230, an optimization tool is executed on a circuit design to collect transistor gate area data associated with a plurality of circuit size instances. The area data can be determined by parsing netlists associated with corresponding circuit size instances to provide transistor gate area calculations. The transistor gate area calculations can include separate calculations for HVT devices and LVT devices. The methodology then proceeds to 240. At 240, power estimates are determined by employing the at least one relational coefficient and the area data. For example, one or more mathematical relationships employing the at least one relational coefficient can be employed to determine an estimate for circuit design power. At 250, the power estimates are compared to determine one or more optimal circuit designs. The one or more optimal circuit designs can then be provided to a more comprehensive power estimation tool to determine actual power estimates.

FIG. 10 illustrates a methodology for estimating power of a circuit design in accordance with another aspect of the present invention. The methodology begins at 300 where HVT transistor gate area calculations and LVT transistor gate area calculations are received. The area calculations can be performed by an area calculator that parses a netlist generated from an optimization tool. At 310, HVT static power estimates are determined employing HVT transistor gate area, HVT static coefficient(s) and static weights. At 320, HVT dynamic power estimates are determined employing HVT transistor gate area, HVT dynamic coefficient(s) and dynamic weights. At 330, HVT total power is computed by adding HVT dynamic power and HVT static power. The methodology then proceeds to 340 to calculate LVT power. The HVT static coefficient(s) and the HVT dynamic coefficient(s) can be determined by a predetermined correlation of power estimates and device data for a plurality of circuit sizing instances for one or more circuit types. The predetermined correlation can be employed to characterize HVT static power and HVT dynamic power to determine one or more coefficients that functionally relate HVT transistor gate area to HVT device static power and dynamic power.

At 340, LVT static power estimates are determined employing LVT transistor gate area, LVT static coefficient(s) and static weights. At 350, LVT dynamic power estimates are determined employing LVT transistor gate area, LVT dynamic coefficient(s) and dynamic weights. At 360, LVT total power is computed by adding LVT dynamic power and LVT static power. The methodology then proceeds to 370 to determine gate leakage power. The LVT static coefficient(s) and the LVT dynamic coefficient(s) can be determined by a predetermined correlation of power estimates and device data for a plurality of circuit sizing instances for one or more circuit types. The predetermined correlation can be employed to characterize LVT static power and LVT dynamic power to determine one or more coefficients that functionally relate LVT transistor gate area to LVT device static and dynamic power.

At 370, gate leakage power is determined by employing LVT transistor gate area calculations, HVT transistor gate area calculations, gate leakage coefficient(s) and static weights. The gate leakage coefficient can be determined by a predetermined correlation that characterizes gate leakage power as a function of LVT and HVT transistor gate area to determine one or more coefficients that functionally relate transistor gate area to gate leakage power. The methodology then proceeds to 380 to compute total power. At 380, total power for the circuit is computed for the circuit sizing instance by adding the total HVT power, the total LVT power and the gate leakage power. The methodology of 300-380 can be repeated for a plurality of circuit sizing instances to determine one or more optimal circuit sizing instances. It is to be appreciated that the HVT static and dynamic coefficients, the LVT static and dynamic coefficients, the gate leakage coefficient(s), the static weights and the dynamic weights can be predetermined based on collecting transistor gate area and power data on a plurality of circuit sizing instances for a plurality of circuit types.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A power estimation system, comprising:
area data associated with transistor gate area of at least one unit of a circuit design; and
a power estimation engine that determines a relative estimation of power for the at least one unit of the circuit design based on a predetermined correlation that characterizes device power as a function of transistor gate area.

2. The system of claim 1, the power estimation engine determines the relative estimation of power by employing at least one coefficient that characterizes device power as a function of transistor gate area.

3. The system of claim 2, the at least one coefficient defining a substantially linear relationship between device power and transistor gate area, such that the at least one coefficient includes a multiplier coefficient and an offset coefficient.

4. The system of claim 1, the relative estimation of power is based on a determination of static power and dynamic power.

5. The system of claim 4, the relative estimation of power is also based on a determination of gate leakage power.

6. The system of claim 1, the area data comprising high voltage threshold (HVT) transistor gate area data and low voltage threshold (LVT) transistor gate area data.

7. The system of claim 6, the power estimation engine employs a first predetermined correlation of power based on HVT transistor gate area data that characterizes HVT device power as a function of HVT transistor gate area and a second predetermined correlation of power based on LVT transistor gate area that characterizes LVT device power as a function of LVT transistor gate area.

8. The system of claim 7, the first predetermined correlation being a first set of at least one coefficient that characterizes HVT device power as a function of HVT transistor gate area and the second predetermined correlation being a second set of at least one coefficient that characterizes LVT device power as a function of LVT transistor gate area, the relative estimation of power for the at least one unit of the circuit design is computed by adding the power determined for the HVT devices and the power determined for the LVT devices.

9. The system of claim 8, the estimation of power for the at least one unit of the circuit design being further computed by adding a gate leakage power estimation based on both the HVT transistor gate area and the LVT transistor gate area and a third set of at least one coefficient based on a predetermined correlation that characterizes gate leakage power as a function of HVT transistor gate area and LVT transistor gate area.

10. The system of claim 1, further comprising an area calculator that generates the area data by analyzing a netlist provided by an optimization tool.

11. The system of claim 10, the area calculator and the power estimation engine cooperate with the optimization tool to generate a plurality of relative power estimates based on a plurality of circuit sizing instances of the at least one unit of the circuit design, the plurality of relative power estimates having a relative relationship to one another based on the predetermined correlation.

12. The system of claim 1, the correlation of power with respect to transistor gate area is determined by analyzing power data and associated transistor gate area data based on a plurality of instances of at least one circuit design type.

13. A system for determining an estimation of power for at least one unit of a circuit design, the system comprising:
a first power estimator that determines an estimation of relative power associated with high voltage threshold (HVT) devices by employing an HVT transistor gate area calculation and a predetermined finctional relationship of HVT transistor gate area to HVT device power;
a second power estimator that determines an estimation of relative power associated with low voltage threshold (LVT) devices by employing an LVT transistor gate area calculation and a predetermined finctional relationship of LVT transistor gate area to LVT device power; and
an adder that adds the relative estimation of powers from the first power estimator and the second power estimator to provide a total relative estimation of power.

14. The system of claim 13, further comprising a third power estimator that determines an estimation of relative power associated with LVT and HVT device gate leakage by employing the LVT transistor gate area calculation and the HVT transistor gate area calculation and a predetermined functional relationship of LVT and HVT transistor gate area to gate leakage power, the adder further adding the relative estimation of power from the third estimator to provide the total relative estimation of power.

15. The system of claim 14, the relationship of HVT transistor gate area to HVT device power being a linear relationship and the relationship of LVT transistor gate area to LVT device power being a linear relationship.

16. The system of claim 14, the power estimate of the first power estimator comprising a HVT static power estimate and a HVT dynamic power estimate and the power estimate of the second power estimator comprising a LVT static power estimate and a LVT dynamic power estimate, the first power estimator and the second power estimator employ dynamic and static weight factors in determining the weight associated with the static and dynamic power estimates.

17. The system of claim 13, further comprising an area calculator that generates the LVT transistor gate area calculation and the HVT transistor gate area calculation by analyzing a netlist defining the at least one unit of a circuit design.

18. The system of claim 17, the area calculator analyzes netlists associated with circuit sizing instances of the at least one unit of the circuit design generated by an optimization tool.

19. A power estimator, comprising:
means for characterizing power as a function of circuit transistor gate area;
means for generating transistor gate area calculations for a plurality of circuit sizing instances associated with a circuit design; and
means for computing relative power estimates of the plurality of circuit sizing instances employing the transistor gate area calculations and the characterization of power as a function of circuit transistor gate area.

20. The power estimator of claim 19, the means for characterizing power as a function of circuit transistor gate area comprising a first characterizing of power as a function of high voltage threshold (HVT) transistor gate area, a second characterizing of power as a function of low voltage threshold (LVT) transistor gate area, and a third characterization of gate device leakage power based on LVT transistor gate area and HVT transistor gate area.

21. The power estimator of claim 20, the means for computing relative power estimates comprising computing relative power estimates associated with HVT transistor gate area, LVT transistor gate area and gate leakage transistor gate area.

22. The power estimator of claim 21, the means for computing relative power estimates computes relative power estimates for both static and dynamic power associated with both HVT devices and LVT devices.

23. A power estimation method for a circuit design, comprising:
calculating the transistor gate area associated with a circuit design; and
estimating relative power by computing a predetermined characterization of power as a function of transistor gate area.

24. The method of claim 23, the predetermined characterization of power as a function of transistor gate area being a substantially linear relationship that employs at least one of a multiplier coefficient and an offset coefficient to define power as a function of transistor gate area.

25. The method of claim 23, the estimating relative power by computing a predetermined characterization of power as a function of transistor gate area comprising computing a first predetermined function of power based on high voltage threshold (HVT) transistor gate area for high voltage threshold (HVT) devices and by computing a second predetermined function of power based on low voltage threshold (LVT) transistor gate area for low voltage threshold (LVT).

26. The method of claim 25, the estimating relative power by computing a predetermined characterization of power as a function of transistor gate area comprising estimating power by computing a third predetermined function of gate leakage power based on transistor gate area for both HVT devices and LVT devices.

27. The method of claim 25, the first predetermined function of power and the second predetermined function of power compute both static and dynamic power based on weights associated with both static and dynamic power.

28. The method of claim 23, further comprising repeating the calculating the transistor gate area associated with a circuit design and the estimating relative power by computing a predetermined characterization of power as a function of transistor gate area.

29. A computer-readable medium having computer-executable instructions for performing the method of claim 23.
